(19) United States
(12) Patent Application Publication
(10) Pub. No.: US 2015/0308140 A1
(43) Pub. Date: Oct. 29, 2015

(54) MODULAR MONOPOLE TOWER FOUNDATION

(71) Applicant: ARE Telecom Incorporated, St. Paul, MN (US)

(72) Inventor: Michael Clifton, Flagstaff, AZ (US)

(21) Appl. No.: 14/699,472

(22) Filed: Apr. 29, 2015

Related U.S. Application Data
(60) Provisional application No. 61/985,729, filed on Apr. 29, 2014.

(51) Int. Cl. E04H 12/22; E02D 27/42; F16M 13/00

(52) U.S. Cl. CPC E04H 12/2246; F16M 13/00; E04H 12/2284; E02D 27/42

(57) ABSTRACT

A foundation for a monopole includes a central portion, a plurality of legs, and a vertically oriented outer perimeter wall surrounding the plurality of legs, wherein a cavity formed within the outer perimeter wall defines a volume configured to contain ballast. Each of the legs has a proximal end and a distal end, wherein each of the plurality of legs is removably attached to the central portion at its proximal end and extends radially from the central portion.

### CROSS REFERENCE TO RELATED APPLICATION

This application claims the benefit of U.S. Provisional Patent Application Ser. No. 61/985,729 entitled “Modular Monopole Tower Foundation,” which was filed on Apr. 29, 2014, the content of which is incorporated by reference in its entirety.

### BACKGROUND

The present disclosure relates to a foundation and raising system for a monopole tower. More particularly, the present disclosure relates to a portable, modular foundation and raising system that can be stored and transported in a compact, disassembled state and assembled on site. The monopole tower is capable of supporting equipment including, but not limited to, wind turbines, solar panels, street lights, communication devices and monitoring systems.

Monopole towers are becoming increasingly utilized in numerous industries including, for instance, renewable wind energy and solar energy and also in the satellite and wireless communication industries. Monopole towers provide the necessary structural support to maintain a wind turbine, solar panels or antennae in an elevated position while reducing capital expenditures necessary for a typical support structure. Monopoles can also be utilized to support meteorological equipment such as an anemometer, wind direction vanes, temperature sensors and pressure sensors. Other applications include use in any industry where an elevated support can be utilized, such as the construction industry, or for street lights, for example.

Typically, monopoles are secured to concrete foundations having footings buried into the ground. Concrete foundations are typically expensive to construct and often require a construction permit. Once constructed, the foundation typically cannot be moved. Therefore, if a location for a monopole is abandoned or becomes obsolete, the foundation is either removed and disposed of or abandoned at the location. In the event that the location is abandoned, the foundation can become a potential hazard.

Further, typical monopole foundations do not provide the capability to raise and lower the monopole and the attached equipment. Having the capability to easily raise and lower the monopole allows access to the equipment at ground level to repair or maintain the equipment. The capability to raise and lower the monopole also allows the owner or operator to protect the equipment secured to the top of a monopole from damage during violent weather. For instance, if a wind turbine secured to a top of a monopole is left raised in the vertical position during a stoim having high wind loads, then the wind turbine or the monopole or both could be damaged.

### SUMMARY

In one aspect, a foundation for a monopole comprises a central portion, a plurality of legs, and a vertically oriented outer perimeter wall surrounding the plurality of legs, wherein a cavity formed within the outer perimeter wall defines a volume configured to contain ballast. Each of the legs has a proximal end and a distal end, wherein each of the plurality of legs is removably attached to the central portion at its proximal end and extends radially from the central portion.

This summary is provided to introduce concepts in simplified faun that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

FIG. I is a perspective view of an exemplary embodiment of a portable and modular monopole foundation with a monopole in a raised position.

FIG. 2 is a perspective view of the monopole foundation of FIG. 1, with the monopole (shown separated into components) in a lowered position.

FIG. 3 is similar to FIG. 2, but shows the monopole components connected and two side walls of the foundation removed, to allow a view of internal components of the foundation.

FIG. 4 is an enlarged view of a portion of FIG. 3.

FIG. 5 is an enlarged view of a portion of FIG. 4.

FIG. 6 is a perspective view of assembly of some components of the exemplary monopole foundation.

FIG. 7 shows additional components assembled onto the structure of FIG. 6.

FIG. 8 shows additional components assembled onto the structure of FIG. 7.

FIG. 9 shows the assembly of additional components onto the structure of FIG. 8.

FIG. 10 shows the assembly of additional components onto the structure of FIG. 9.

FIG. 11 shows assembly of additional components onto the structure of FIG. 10.

FIG. 12 shows a second exemplary embodiment, wherein the foundation includes an inner wall spaced from the outer wall.

FIG. 13 is similar to FIG. 1, but shows additional elements assembled onto the monopole foundation.

FIG. 14 is a perspective view of the embodiment of FIG. 13, with the monopole in a partially raised position and with components and enclosures of the foundation in an open configuration.

The disclosed subject matter will be further explained with reference to the attached figures, wherein like structure or system elements are referred to by like reference numerals throughout the several views.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where terms such as above, below, over, under, top, bottom, side, right, left, etc., are used, it is to be understood that they are used only for ease of understanding the description. It is contemplated that structures may be oriented otherwise.

### DETAILED DESCRIPTION

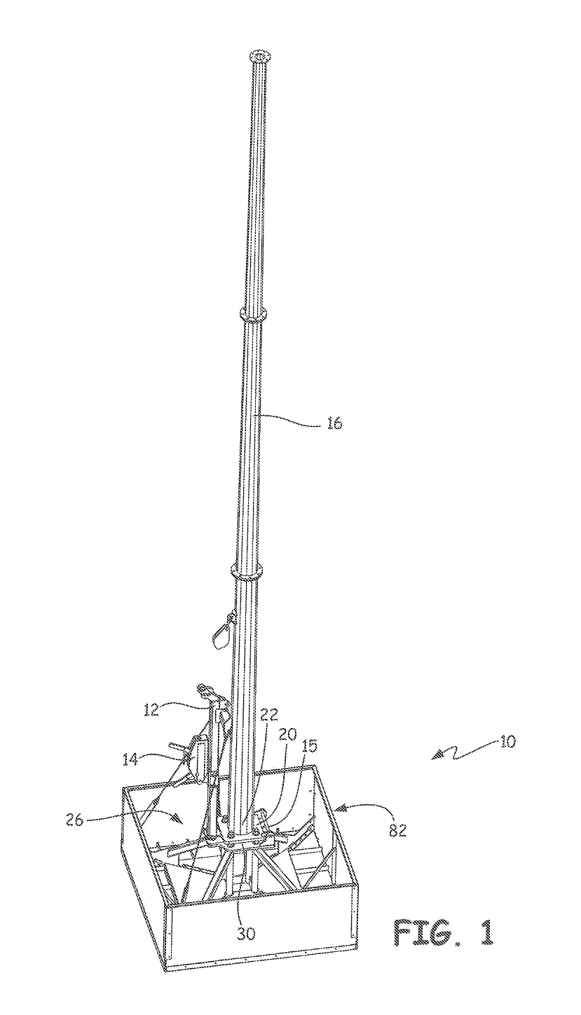

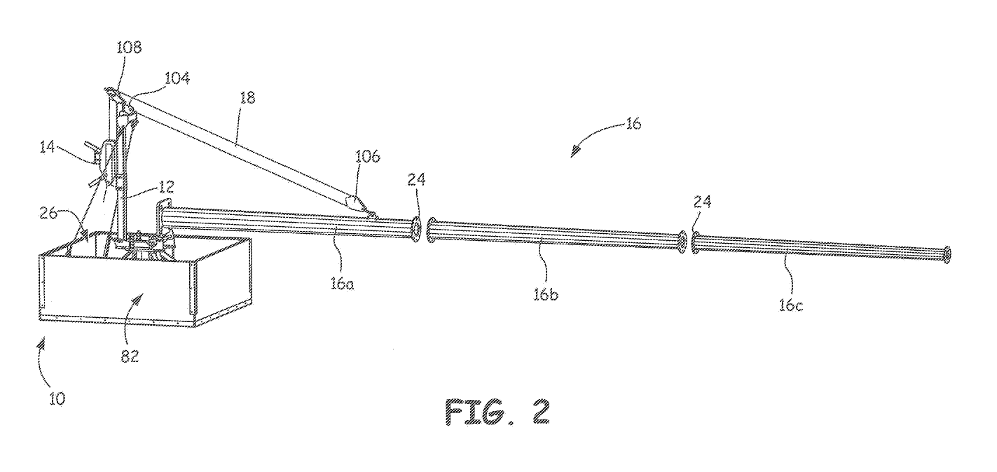

An exemplary portable and modular foundation 10 is used with a gin pole 12 having a raising and lowering winch 14 that is coupled to a monopole 16 with a cable 18 (shown in FIG. 2). The winch 14 utilizes the mechanical advantage of the gin pole 12 to raise and lower the monopole 16 by manipulating a length of the cable 18. The foundation 10 can be stabilized with ballast (not shown) above ground or buried, depending upon the application. FIG. 2 illustrates that monopole 16 can be formed from a plurality of sections that are connected together at joints 24, such as with fasteners including bolts, for example. While three monopole sections 16a, 16b, 16c are shown, it is contemplated that more or fewer sections can be used, with considerations for the number of sections including portability requirements and a desired final height of monopole 16, for example.

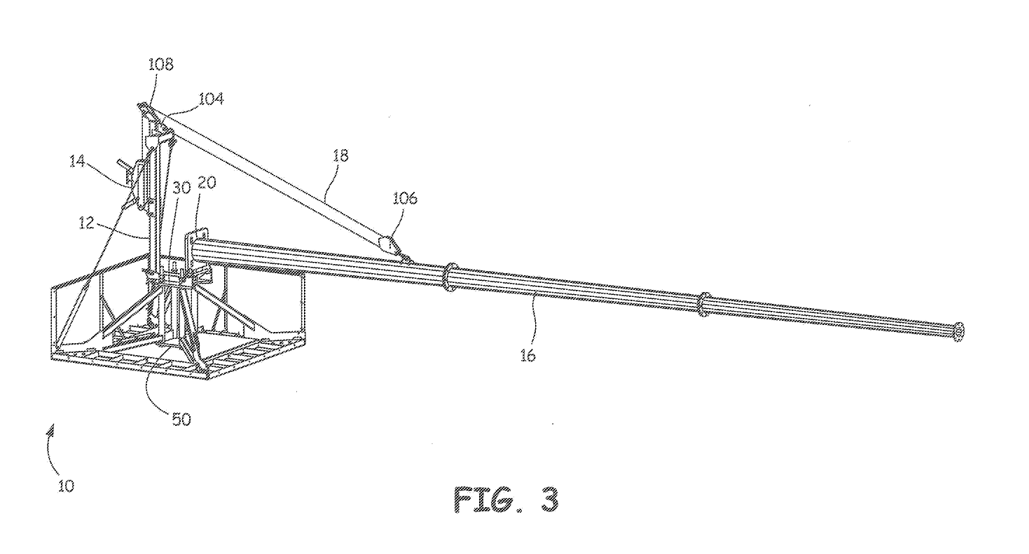

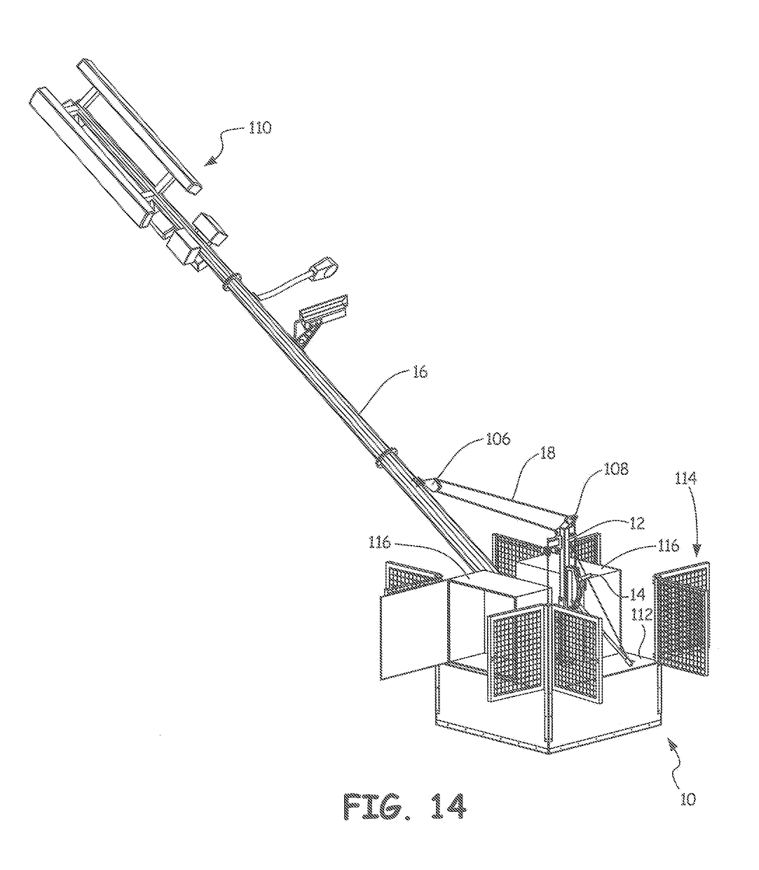

Referring to FIGS. 3-5, in an exemplary embodiment, the monopole 16 is pivotally attached to the foundation 10 with a pivot pin 15. Through manipulation of the winch 14, which causes the effective length of the cable 18 to be reduced, and the mechanical advantage of the gin pole 12, the monopole 16 is pivoted about the pivot pin 15 to move from the lowered position illustrated in FIGS. 3-5; through a raised intermediate position relative to the foundation 10, as illustrated in FIG. 14; and to a fully raised, substantially vertical position, as shown in FIG. 1. With the monopole 16 in the fully raised position, a platform 20 attached to a bottom end 22 of the monopole 16 is positioned substantially horizontally and parallel to central mounting plate 30 of foundation 10, as shown in FIG. 1. Conversely, when the monopole 16 in the lowered position platforn 20 is positioned substantially vertically and perpendicular relative to central mounting plate 30 of foundation 10, as shown in FIGS. 3-5.

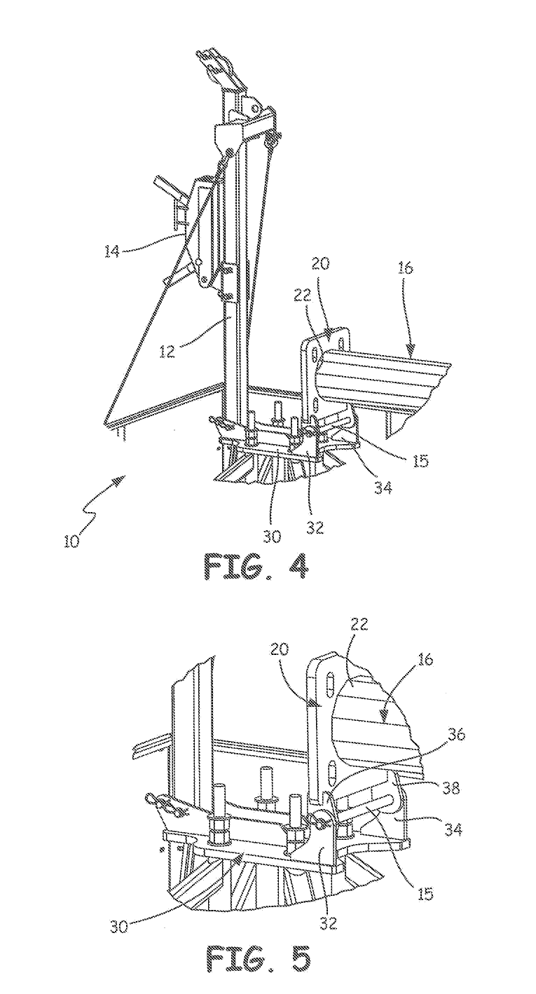

Referring to FIG. 4, a bottom end 22 of the monopole 16 is fixedly secured to platform 20 of foundation 10. The platform 20 includes left and right mounting brackets 32 and 34, respectively that have aligned apertures for the passage of pivot pin 15. As shown in FIG. 5, the platform 20 attached to the bottom end 22 of the monopole 16 includes left and right mounting flanges 36 and 38, respectively, having aligned apertures such that the pivot pin 15 can be secured therethrough to pivotally attach platform 20 to central mounting plate 30.

Referring to FIG. 6, the foundation 10 includes a bottom plate 50 that is typically square in configuration. However, other geometric configurations are also contemplated. The bottom plate 50 includes apertures 48 located proximate the corners of plate 50, through which bolts 52 are inserted. Support legs 59 are positioned between bottom plate 50 and central mounting plate 30 so that a bolt 52 passes through aperture 48 of bottom plate 50, spacer 54 of support leg 59, and aperture 46 of central mounting plate 30. A washer 56 is typically positioned about each bolt 52 below bottom plate 50 at aperture 48 and above central mounting plate 46 at aperture 46. In an exemplary embodiment, an assembly of the bottom plate 50, a support leg 59, and the central mounting plate 30 is secured by a threaded engagement of each bolt 52 and one or more nuts 58.

A plurality of support legs 59 extend radially from central mounting plate 30. In an exemplary embodiment, each support leg 59 of foundation 10 includes the spacer 54 having buses at the bottom and top ends to such that the buses can be positioned into the apertures 46 & 48 of the central mounting plate 30 for additional strength. A bottom member 60 that is attached to the spacer 54 proximate a bottom end 62 of the spacer 54, and an angled top member 64 attached to the spacer 54 proximate a top end 66 of the spacer 54. The bottom member 60 and the angled top member 64 are attached to the spacer 54 with a weld in an exemplary embodiment. However, other attaching mechanisms can also be used. In an exemplary embodiment, each spacer 54 is configured as a tubular sleeve into which bolt 52 may be inserted. The bottom member 60, the spacer 54, and the angled top member 64 are typically formed of tubular metal, such as steel. However, other configurations and materials of the bottom member 60, the spacer 54, and the angled top member 64 can also be used. Moreover, while four support legs 59 are shown, it is contemplated that three or more support legs would be suitable. In an exemplary embodiment from support legs 59 are equally spaced about central mounting plate 30.

A distal portion of each support leg 59 includes a vertical plate 67 that joins the bottom member 60 and the angled top member 64. In an exemplary embodiment, the vertical plate 67 is positioned within notches or slots 72, 74 in the respective bottom member 60 and the respective top member 64 at the distal ends thereof Typically, the vertical plate 67, bottom member 60 and top member 64 are secured to each other by welding. However other securing mechanisms are also contemplated including, but not limited to, a nut and bolt threaded engagement and a rivet.

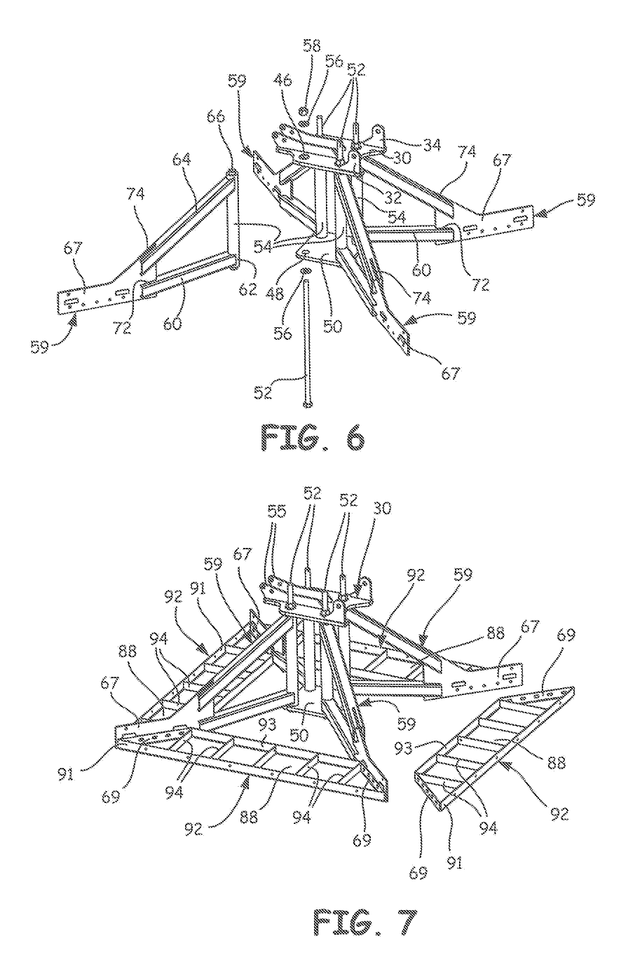

As shown in FIG. 7, a perimeter floor panel 92 is positioned between adjacent support legs 59. In an exemplary embodiment, a bottom edge of vertical plate 67 of each support leg 59 is secured to mounting flanges 69 located at side edges floor panels 92. The mounting flange 69 includes a plurality of mounting apertures that allow the plate 67 to be secured thereto, typically with fasteners such as bolts and nuts and/or a weld. In an exemplary embodiment, perimeter floor panels 92 includes floor plate 88 and spaced apart, vertically oriented floor braces 94 that provide structural integrity to the foundation 10.

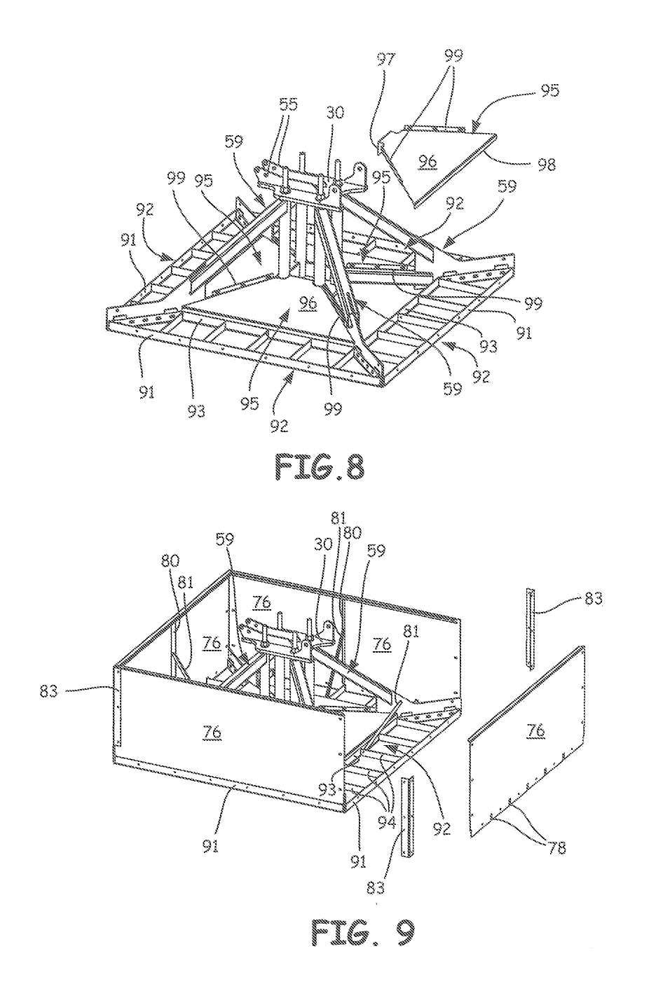

FIG. 8 shows the insertion of a plurality of interior floor panels 95. In an exemplary embodiment, each interior floor panel 95 has a floor surface 96 configured to fit between adjacent support legs 59. In the illustrated embodiment, floor surface 96 is raised, in that it is supported on a ground surface by proximal vertical flange 97 and distal vertical flange 98. In an exemplary embodiment, proximal flange 97 and distal flange 98 of interior floor panel 95 have a similar height dimension as mounting flange 69 and floor braces 94 of perimeter floor 92. Interior floor panels 95 further include side flanges 99 having apertures therein, wherein side flanges 99 of adjacent interior floor panels 95 are attachable to each other by means including the use of fasteners such as bolts through the apertures, and optionally also, or alternatively, with a weld.

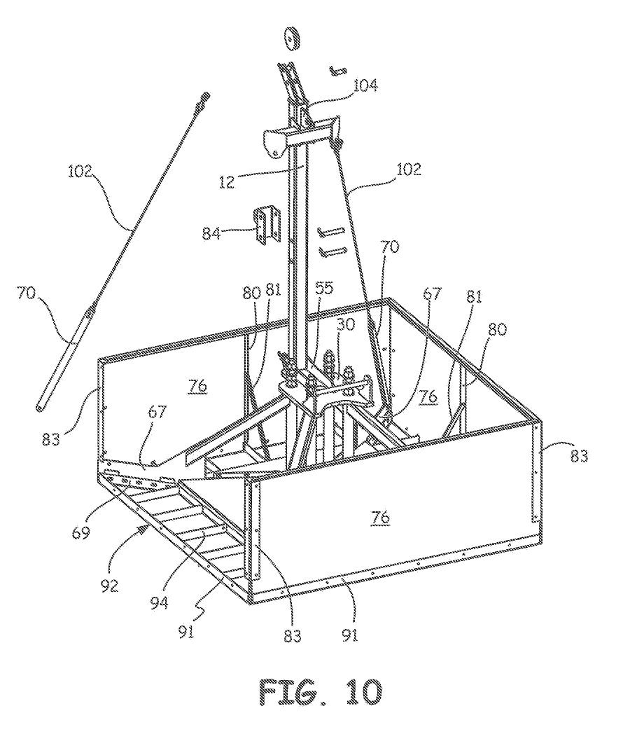

As shown in FIG. 9, in an exemplary embodiment, perimeter floor panels 92 connect to a vertically oriented, continuous outer perimeter wall 82 (shown in FIGS. 1 and 2) formed of perimeter wall panels 76, joined at their joints by corner braces 83. Corner braces 83 have apertures that align with apertures of the perimeter wall panels 76, such that the perimeter wall panels 76 can be fastened together. Each perimeter floor panel 92 includes a raised outer lip 91 that includes apertures for mounting the bottom edge of a perimeter wall panel 76. The outer perimeter wall 82 surrounds the plurality of support legs 59. In the illustrated embodiment, the outer perimeter wall 82 forms a rectangular or square outer wall that has four sides. However, an outer perimeter wall 82 with a different geometry can also be used with a perimeter floor of corresponding geometry. In an exemplary embodiment, each of perimeter wall panels 76 has slots 78 on a bottom edge thereof to accommodate floor braces 94 of a perimeter floor panel 92 when the perimeter wall panel 76 is inserted onto the perimeter floor panel 92. In an exemplary embodiment, an upright support 80 is provided on an interior surface of a perimeter wall panel 76 and is attached by wall brace 81 to a floor brace 94 of perimeter floor panel 92.

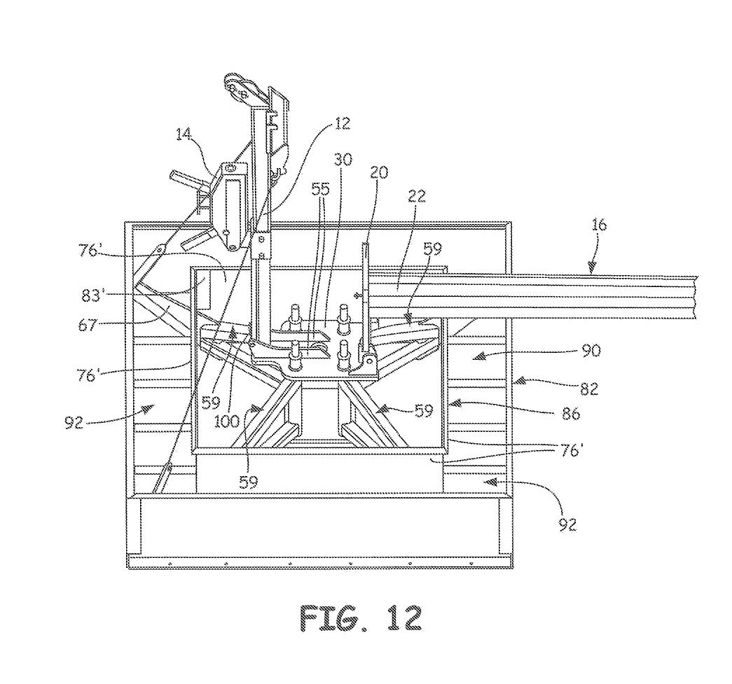

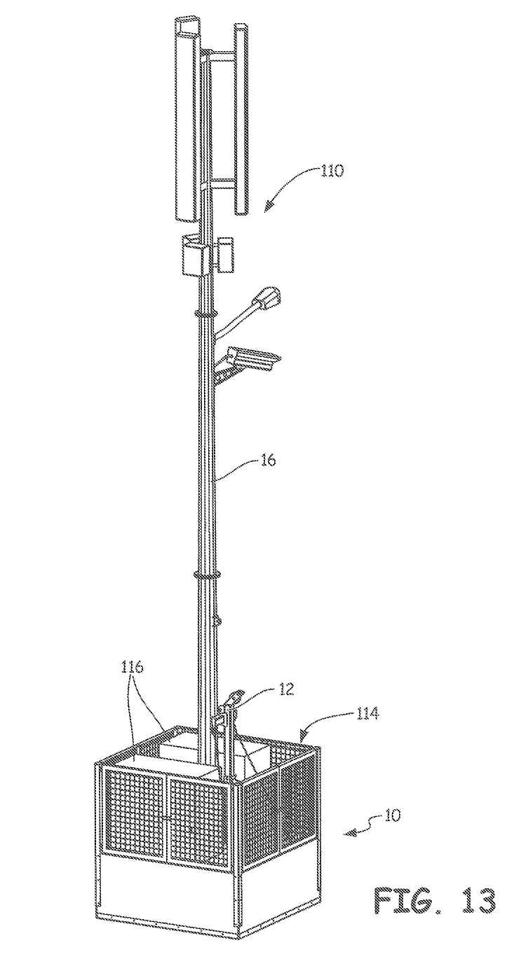

As illustrated in FIG. 10, in an exemplary embodiment, a guy wire link 70 is secured to each of two adjacent plates 67, typically with a bolt and nut, such that the guy wire link 70 is pivotally attached to the plate 67. A top portion of the gin pole 12 is attached to the guy wire links 70 by guy wires 102. A bottom portion of the gin pole 12 is pivotally attached to the central mounting plate 30 with a pivot pin positioned through the gin pole 12 and a mounting bracket 55 that is attached to the central mounting plate 30. As shown in FIG. 12, a pin 100 is positioned on a side of the gin pole 12 within the mounting bracket 55 to provide support to the upright gin pole 12. Guy wires 102 are secured proximate a top portion of the gin pole 12 and also to the guy wire link 70 such that the interaction between the guy wires 102 with the pin 100 retain the gin pole 12 in the upright position.

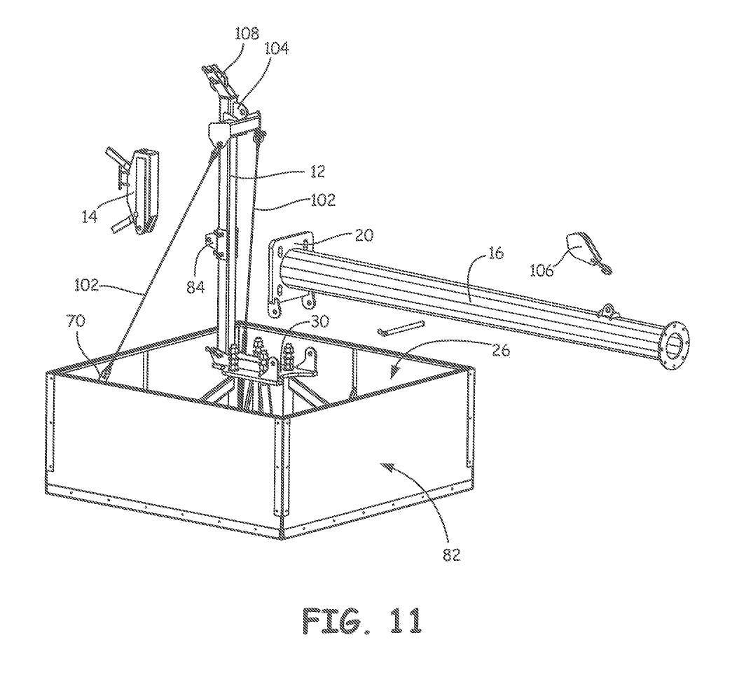

FIG. 11 is an exploded view that illustrates winch 14, which is configured for attachment to gin pole 12 at hoist bracket 84. Platform 20 of monopole 16 is attached to central mounting plate 30 as discussed above. As shown in FIGS. 2 and 3, cable 18 is attached at one end to gin pole 12 at bracket 104. Cable 18 travels around snatch block 106, which is attached to monopole 16. Cable 18 continues around sheave 108 to winch 14. Manipulation of the winch 14 changes the effective length of the cable 18, which raises and lowers the monopole 16. The mechanical advantage provided by the use of the gin pole 12 and the cable 18, especially when a piece of equipment is attached to the monopole 16, allows the monopole 16 to be more easily raised and lowered. This ability to raise and lower monopole 16 can be of a benefit especially when inclimate weather is approaching that could damage the monopole or the equipment attached thereto. While a rigging system using gin pole 12 is shown, it is contemplated that other lifting mechanisms to raise and lower monopole 16 can be used, including but not limited to manual screw jacks, hydraulic rams, electric powered actuators and other raising and lowering mechanisms. Other examples of raising systems for a monopole include the subject matter of U.S. patent application Ser. No. 13/405,542, published at Patent Application Publication No. 2012/0228442, entitled “Portable Modular Monopole Tower Foundation,” which is incorporated by reference in its entirety. Another example of a monopole raising system is found in the subject matter of U.S. Pat. No. 8,960,615, entitled “Portable Modular Monopole Tower Foundation,” which is incorporated by reference in its entirety.

To counteract the weight of the moving monopole 16, ballast (not shown) may be placed into the cavity 26 formed within outer perimeter wall 82. The cavity 26 within outer perimeter wall 82 defines a volume into which ballast can be placed to provide stability to raise and lower a monopole 16, with or without equipment 110 attached thereto, while also being capable of withstanding the torque created by a wind load on the elevated equipment 110 and the monopole 16. Such ballast may include concrete blocks or earth anchors, for example. Other examples include materials that can be obtained on site, such as dirt, gravel and sand. In an exemplary embodiment, the cavity 26 formed within outer perimeter wall 82 can contain about six cubic yards of ballast. Ballast having a bulk density of about 2,700 pounds per cubic yard (about 16 kN/m³) is especially suitable. Because of the weight of a filled foundation 10, selection of a suitable site for installation of foundation 10 preferably includes a ground surface having a soil bearing pressure of at least about 1,671 foot pounds per square foot (about 80 kPa).

The U.S. Patent Application Publication No. US 2012/0228442, which is assigned to American Resource & Energy, Inc., and is hereby incorporated by reference, describes that ballast in the form of concrete blocks can be provided around the perimeter of the foundation. In contrast, the present disclosure provides a vertically oriented outer perimeter wall 82 to contain ballast, therefore allowing for the use of bulk materials such as dirt, gravel, and sand, for example, that do not have the structure to remain in position without such an outer perimeter wall 82 to define a cavity 26 for containing the ballast.

FIG. 12 shows an embodiment of foundation 10 that also includes an inner wall 86 that intersects the legs 59 between proximal and distal ends of the legs 59. In the illustrated embodiment, the inner wall 86 has a rectangular or square form that has four sides. However, an inner wall 86 with a different geometry can also be used. Generally, inner wall 86 is similar in geometry with outer wall 82 and is concentric therewith. In many respects, inner wall 86 is similar in construction to outer perimeter wall 82. Inner wall panels 76′ are similar in construction to perimeter wall panels 76, but in the illustrated embodiment generally have a smaller width dimension. Corner braces 83′ are configured in the illustrated embodiment to attach on inside corners of the formed inner wall 86. Moreover, as illustrated, corner braces 83′ are not as long as corner braces 83. As shown in FIG. 12, corner braces 83′ extend from a top extent of inner wall panels 76′ to a point just above vertical plate 67. Where two adjacent inner wall panels 76′ meet at a corner, a slot or notch formed at the corner below corner braces 83′ accommodates the passage of vertical plate 67. A bottom edge of each inner wall panel 76′ includes slots similar to slots 74 in perimeter wall panel 76 to accommodate floor braces 94 of perimeter floor panel 92, as each inner wall panel 76 is inserted onto perimeter floor panel 92 adjacent inner lip 93 (shown in FIG. 8).

The floor panels 92, the inner wall 86 and the outer wall 82 define an annular channel 90 into which ballast can be positioned to provide the necessary support to the foundation 10 to allow the monopole 16 to be raised and lowered. The ballast counteracts the torque placed on the foundation 10 as the monopole 16 is raised and lowered and also aids in retaining the monopole in the elevated position. When more ballast volume is desired, the ballast can also be positioned to fill a volume within inner wall 86.

FIGS. 13 and 14 show a monopole 16 supported on a foundation 10, with additional equipment 110 supported on monopole 16. Moreover, a lid or cover 112 is provided on foundation 10 over outer perimeter wall 82. In this illustrated embodiment, cover 112 supports an additional enclosure 114, which can contain components 116 and/or additional ballast. In an exemplary embodiment, each component 116 is a housing for protecting equipment such as controllers, electronics, and power sources, for example. In an exemplary embodiment, enclosure 114 is formed with mesh walls and is provided to prevent tampering with components 116. In an exemplary embodiment, each of enclosures 114 and components 116 is formed with hinged parts that can be opened and closed. To provide a sense of scale, in an exemplary embodiment, a height of foundation 10 with enclosure 114 can be approximately seven feet, for example. The side surfaces of foundation 10 and enclosure 114 can be provided with banners with visual indicia bearing advertising, warnings, instructions, and other information.

An exemplary foundation 10 includes a plurality of components that can be transported in a disassembled, compact configuration. For example, each of the plurality of support legs 59 is substantially identical and can be transported as separate components that can stack one on top of the other to conserve space. Moreover, because of their interchangeability, a single extra support leg 59 may be included to replace any of the support legs 59 that may be damaged. Similarly, foundation 10 includes a plurality of identical and stackable guy wire links 70 with guy wires 102, wall panels 76, 76′, wall braces 81, corner braces 83, 83′, perimeter floor panels 92, and interior floor panels 95, for example. These components can be assembled and secured together using bolts and nuts or other conventional fasteners at the site, thereby allowing the foundation 10 to be assembled utilizing typically available tools such as wrenches and ratchets with sockets. Because the foundation 10 can be assembled on site, the disassembled foundation 10 can be transported to remote locations in a compact, disassembled state relative to a foundation that is pre-assembled. Additionally, if the location of the foundation 10 and monopole 16 with the equipment becomes undesirable, the monopole 16 and the associated equipment can be lowered and removed from the foundation 10. Further, the foundation 10 can be disassembled for transport from the site by removing the nuts from the bolts.

Although the present disclosure has been described with reference to preferred embodiments, workers skilled in the art will recognize that changes may be made in form and detail without departing from the spirit and scope of the invention. In addition, any feature disclosed with respect to one embodiment may be incorporated in another embodiment, and vice-versa.

1. A foundation for a monopole comprising:
a central portion;
a plurality of legs, each of the legs having a proximal end and a distal end, wherein each of the plurality of legs is removably attached to the central portion at its proximal end and extends radially from the central portion; and
a vertically oriented outer perimeter wall surrounding the plurality of legs and secured to distal ends thereto;
wherein a cavity formed within the outer perimeter wall defines a volume configured to contain ballast.

2. The foundation of claim 1 further comprising an interior floor panel positioned between adjacent legs of the plurality of legs.

3. The foundation of claim 2 wherein the interior floor panel comprises a raised floor surface supported on at least one vertically oriented flange.

4. The foundation of claim 1 further comprising a perimeter floor panel positioned between adjacent legs of the plurality of legs, wherein the perimeter floor panel comprises a vertically oriented floor brace.

5. The foundation of claim 4 wherein the outer perimeter wall comprises a slot to accommodate the floor brace.

6. The foundation of claim 1 wherein the outer perimeter wall comprises a plurality of wall panels.

7. The foundation of claim 6 further comprising a corner brace at a joint between adjacent wall panels.

8. The foundation of claim 1 wherein the outer perimeter wall comprises an upright support.

9. The foundation of claim 8 further comprising a wall brace attached to the upright support.

10. The foundation of claim 9 further comprising a perimeter floor panel positioned between adjacent legs of the plurality of legs, wherein the perimeter floor panel comprises a vertically oriented floor brace attached to the wall brace.

11. The foundation of claim 1 further comprising an inner wall intersecting the plurality of legs between the respective proximal and distal ends of the plurality of legs, wherein a channel is defined between the inner wall and the outer perimeter wall.

12. The foundation of claim 11 wherein the inner wall is concentric with the outer perimeter wall.

13. The foundation of claim 11 further comprising a floor panel, wherein the inner wall and the outer perimeter wall are positioned on opposite sides of the floor panel.

14. The foundation of claim 13, wherein the floor panel comprises one or more floor braces.

15. The foundation of claim 14, wherein the inner wall comprises a slot to accommodate the floor brace.

16. The foundation of claim 1, further comprising a cover positioned over the outer perimeter wall.

17. The foundation of claim 16, further comprising a component disposed on the cover.

18. The foundation of claim 17, further comprising an enclosure surrounding the component.

19. The foundation of claim 17, wherein the component is a housing.

20. The foundation of claim 1, wherein the outer perimeter wall is continuous.
